(19) United States
(12) Patent Application Publication
(10) Pub. No.: US 2014/0042952 A1
(43) Pub. Date: Feb. 13, 2014

(54) APPARATUS AND METHOD FOR PREVENTING SENSING ERROR IN SRM

(71) Applicant: SAMSUNG ELECTRO-MECHANICS CO., LTD., Suwon (KR)

(72) Inventors: Joung Ho Son, Suwon (KR); Dae Sung Kim, Suwon (KR); Hyung Joon Kim, Suwon (KR); Mu Seon Woo, Suwon (KR); Hong Chul Shin, Suwon (KR); Sang Moon Choi, Suwon (KR)

(73) Assignee: SAMSUNG ELECTRO-MECHANICS CO., LTD., Suwon (KR)

(21) Appl. No.: 13/956,151

(22) Filed: Jul. 31, 2013

(30) Foreign Application Priority Data
Aug. 9, 2012 (KR) 10-2012-0087399

(51) Int. Cl. H02P 25/08

(52) U.S. Cl. CPC H02P 25/082
USPC 318/701

(57) ABSTRACT

Disclosed herein are an apparatus and method for preventing a sensing error in a switched reluctance motor (SRM). The apparatus includes: a rectifying unit; a main controlling unit driven by power supplied from the rectifying unit, and operated in an error mode in the case in which the rotation speed of the rotor is decreased to a predetermined value or less; a voltage detecting; and an error preventing unit preventing an operation of the main controlling unit in an error mode at the time of reconnection of a power supply when it is sensed that the power has been blocked using the variation in the supplied voltage detected by the voltage detecting unit.

### CROSS REFERENCE TO RELATED APPLICATION

This application claims the benefit of Korean Patent Application No. 10-2012-0087399, filed on Aug. 9, 2012, entitled “Preventing Apparatus for Sensing Error in the SRM and Method Thereof”, which is hereby incorporated by reference in its entirety into this application.

### BACKGROUND OF THE INVENTION

1. Technical Field

The present invention relates to an apparatus and method for preventing a sensing error in a switched reluctance motor (SRM).

2. Description of the Related Art

In a switched reluctance motor (hereinafter, referred to as a SRM), which is a motor having a form in which it has a switching control apparatus coupled thereto, both of a stator and a rotor are formed in a salient type structure.

Particularly, since only a stator part has a winding wound therearound and a rotor part does not include any type winding or permanent magnet, the SRM has a simple structure.

Due to this structural feature, the SRM has a significant advantage in view of manufacturing and production, and has good start-up characteristics and a large torque, similar to a direct current motor. In addition, the SRM requires less maintenance and has excellent characteristics in view of a torque per unit volume, efficiency, rating of a converter, and the like, such that the use of the SRM has gradually increased in various fields.

The SRM as described above has been used in a cleaner field.

In the cleaner field, a normal operation of a suction motor for a cleaner is to generate suction force while maintaining a predetermined RPM and to maintain a predetermined suction force by increasing a speed since an amount of sucked fluid decreases to decrease a load of the motor when an amount of dust or foreign materials increases.

Therefore, in the case in which the RPM of the motor suddenly decreases, it is judged that damage is generated in the motor or abnormality is generated in a controlling unit to stop the motor and generate a corresponding error code.

However, unlike a general motor for a cleaner, in the SRM, a controlling unit converts alternate current (AC) power into direct current (DC) voltage and then uses the DC voltage. In this case, the controlling unit uses a large capacitance capacitor in order to smooth the power.

However, the large capacitance capacitor supplies current charged therein to the controlling unit even though the power is blocked, thereby operating the controlling unit for a predetermined time even in the state in which the power is blocked.

As a result, the controlling unit is operated in an error mode due to a speed decrease of the SRM even with respect to a normal speed decrease of the SRM due to the blocking of power rather than a speed decrease of the SRM due to damage of the SRM or abnormality of the controlling unit to continuously generate a corresponding error code and store the corresponding error code in a memory.

Therefore, in the case in which a power supply is subsequently connected to the controlling unit, the controlling unit is again operated in the error mode due to the error code stored in the memory to inform a user that an error occurs through a display unit, or the like, thereby generating an unnecessary product repair request or performing a self-error correction operation which is an unnecessary operation.

### PRIOR ART DOCUMENT

### Patent Document

(Patent Document 1) Korean Patent Laid-open Publication No. 2003-59659

### SUMMARY OF THE INVENTION

The present invention has been made in an effort to provide an apparatus and method for preventing a sensing error in a switched reluctance motor (SRM) capable of preventing an operation in an error mode at the time of subsequent connection of a power supply by detecting a variation in direct current (DC) voltage and judging that power has been blocked when the DC voltage is decreased to voltage or less of commercial power to perform a normal motor stop operation.

According to a preferred embodiment of the present invention, there is provided an apparatus for preventing a sensing error in an SRM, the apparatus including: a rectifying unit receiving AC voltage into DC voltage and supplying the DC power via a capacitor; a main controlling unit driven by power supplied from the rectifying unit, receiving a rotation speed of a rotor of the SRM to control the SRM, and operated in an error mode in the case in which the rotation speed of the rotor is decreased to a predetermined value or less; a voltage detecting unit detecting a variation in the DC voltage supplied from the rectifying unit via the capacitor; and an error preventing unit preventing an operation of the main controlling unit in an error mode at the time of reconnection of a power supply when it is sensed that the power has been blocked using the variation in the supplied voltage detected by the voltage detecting unit.

The main controlling unit may generate and store an error code in the case in which the rotation speed of the rotor is decreased to the predetermined value or less, and the error preventing unit may prevent the operation of the main controlling unit in the error mode by deleting the error code of the main controlling unit at the time of the reconnection of the power supply when it is sensed that the power has been blocked using the variation in the supplied voltage detected by the voltage detecting unit.

The error preventing unit may judge that the power has been blocked in the case in which a variation rate per time in the supplied voltage detected by the voltage detecting unit is a predetermined value or more.

The error preventing unit may judge that the power has been blocked in the case in which the supplied voltage detected by the voltage detecting unit is a predetermined value or less.

The voltage detecting unit may include a current limiting resistor limiting current input from the rectifying unit via the capacitor.

The voltage detecting unit may include a current divider dividing current input from the rectifying unit via the capacitor, and the error preventing unit may use any one of the DC voltages divided by the current divider.

The voltage detecting unit may include a low pass filter removing high frequency noise input the voltage detecting unit.

The rectifying unit may receive the AC voltage from an external AC power supply, convert the AC voltage into the DC voltage, and supply the DC voltage to the SRM via an inverter.

The error preventing unit may transmit an SRM stop signal to the main controlling unit when it is sensed that the power has been blocked, and the main controlling unit may stop start-up of the SRM when the SRM stop signal is input from the error preventing unit.

According to another preferred embodiment of the present invention, there is provided a method for preventing a sensing error in an SRM, the method including: (A) detecting, in a voltage detecting unit, a variation of DC voltage supplied from a rectifying unit via a capacitor; and (B) preventing, in an error preventing unit, an operation of a main controlling unit in an error mode at the time of reconnection of a power supply when it is sensed that the power has been blocked using the variation in the supplied voltage detected by the voltage detecting unit.

The method may further include: (C) transmitting, in the error preventing unit, an SRM stop signal to the main controlling unit when it is sensed that the power has been blocked using the variation in the supplied voltage detected by the voltage detecting unit; (D) stopping, in the main controlling unit, start-up of the SRM when the SRM stop signal is input from the error preventing unit.

In step (B), the error preventing unit may judge that the power has been blocked in the case in which a variation rate per time in the supplied voltage detected by the voltage detecting unit is a predetermined value or more.

In step (B), the error preventing unit may judge that the power has been blocked in the case in which the supplied voltage detected by the voltage detecting unit is a predetermined value or less.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram of an apparatus for preventing a sensing error in a switched reluctance motor (SRM) according to a first preferred embodiment of the present invention;

FIG. 2 is a configuration diagram of an apparatus for preventing a sensing error in an SRM according to a second preferred embodiment of the present invention; and

FIG. 3 is a flow chart a method for preventing a sensing error in an SRM according to the first preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

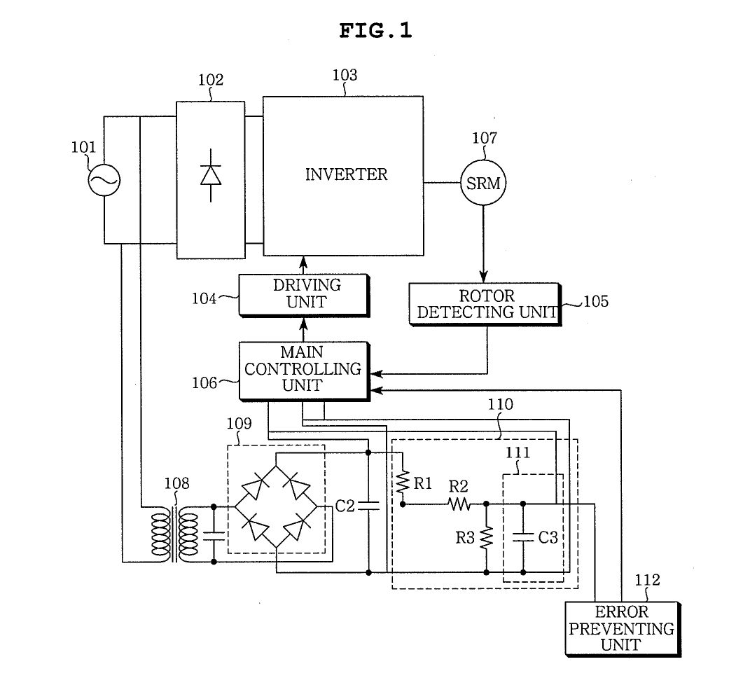

FIG. 1 is a configuration diagram of an apparatus for preventing a sensing error in a switched reluctance motor (SRM) according to a first preferred embodiment of the present invention.

Referring to FIG. 1, the apparatus for preventing a sensing error in an SRM according to the first preferred embodiment of the present invention is configured to include a first rectifying unit 102 receiving alternate current (AC) voltage from an external AC power supply 101, converting the AC voltage into direct current (DC) voltage, and outputting the DC voltage, an inverter 103 converting the DC voltage from the first rectifying unit 102 into AC voltage and supplying the AC voltage to an SRM 107, an inverter driving unit 104 driving the inverter 103, a rotor detecting unit 105 detecting a rotation speed of a rotor of the SRM 107, a main controlling unit 106 receiving a detection signal from the rotor detecting unit 105 and reflecting the detection signal in controlling the inverter driving unit 104, a transformer 108 transforming AC voltage from the AC power supply 101 into AC voltage having a magnitude different from that of the AC voltage, a second rectifying unit 109 receiving voltage at a secondary side of the transformer 108 and converting the voltage at the secondary side into DC voltage and outputting the DC voltage, a voltage detecting unit 110 detecting output voltage from the second rectifying unit 109 to detect a variation in power supply voltage, and an error preventing unit 112 detecting whether the power has been blocked using the voltage detected by the voltage detecting unit 110 to prevent an operation in an error mode at the time of connection of the power supply after a stop operation of the main controlling unit 106.

Here, the second rectifying unit 109 supplies the DC voltage to the main controlling unit 106. Here, the DC voltage is supplied via a capacitor C2.

Here, the voltage detecting unit 110 includes a current limiting resistor R1 preventing generation of overcurrent by the output voltage from the second rectifying unit 109, a plurality of voltage dividing resistors R2 and R3 setting the output voltage of the second rectifying unit 109 to be less than a predetermined voltage value, and a low pass filter 111 configured of a capacitor C3 removing high frequency noise mixed with voltages divided and supplied by the plurality of voltage dividing resistors R2 and R3.

In FIG. 1, a reference numeral C1 indicates a capacitor removing a surge component mixed with voltage induced to the secondary side of the transformer 108, and a reference numeral C2 indicates a smoothing capacitor removing a pulsation component of the DC voltage output from the second rectifying unit 109.

In the apparatus for preventing a sensing error in an SRM according to the first preferred embodiment of the present invention, the first rectifying unit 102 converts the AC power applied from the AC power supply 101 into the DC voltage and outputs the DC voltage, and the inverter 103 receives the DC voltage output from the first rectifying unit 102 and converts the DC voltage into the AC voltage appropriate for driving the SRM 107 and outputs the AC voltage.

Therefore, when the SRM 107 is driven, the rotor detecting unit 105 detects the rotation speed of the rotor and transmits the detection signal to the main controlling unit 106, and the main controlling unit 106 receives the detection signal from the rotor detecting unit 105, compares the detection signal with a set reference signal, and transmits a control command corresponding to the comparison result to the inverter driving unit 104.

In this case, the inverter driving unit 104 controls voltage applied to the SRM 107 according to the control command. As a result, the rotation speed of the SRM 107 is controlled.

In addition, the transformer 108 transforms the voltage from the AC power supply 101 into voltage having a magnitude different from that of the voltage from the AC power supply 101 according to a turn ratio between primary and secondary coils, and the second rectifying unit 109 receives the voltage at the secondary side of the transformer 108 and converts the voltage at the secondary side of the transformer into the DC voltage and outputs the DC voltage.

In a series of processes as described above, in the case in which the voltage of the external AC power supply 101 is varied, the output voltage of the first rectifying unit 102 is also varied.

As described above, in the case in which the voltage of the AC power supply 101 is varied, the output voltage of the first rectifying unit 102 is also varied, such that the rotation speed of the SRM 107 is varied.

Further, in the case in which the voltage of the external AC power supply 101 is varied, the voltage induced to the secondary side of the transformer 108 and the output voltage of the second rectifying unit 109 are also varied.

Here, the DC voltage output from the second rectifying unit 109 is divided in a predetermined ratio by the resistors R2 and R3 of the voltage detecting unit 110, such that the variation in the DC voltage is reflected.

In this case, the error preventing unit 112 receives voltage in which the variation is reflected by the resistor R3 in the divided voltages and judges the variation in the DC power.

Meanwhile, in the case in which the voltage of the external AC power supply 101 is blocked, the output voltage of the first rectifying unit 102 is also blocked.

As described above, in the case in which the voltage of the AC power supply 101 is blocked, the output voltage of the first rectifying unit 102 is also blocked, such that the rotation speed of the SRM 107 is decreased.

However, in the case in which the power is blocked, the main controlling unit 106 is operated for a predetermined time since current charged in a large capacitance capacitor C2 continuously supplies the power even though the power is removed.

As a result, when the power is suddenly blocked, the speed of the SRM 107 is rapidly decreased, but the main controlling unit 106 is continuously operated, such that the main controlling unit 106 is operated in an error mode due to the speed decrease of the SRM output from the rotor detecting unit 105 to continuously generate an error code and store the generated error code in a memory.

As described above, when the error code is generated by the main controlling unit 106 and the generated error code is stored in the memory, in the case in which the power supply is subsequently connected to the main controlling unit 106, the main controlling unit 106 judges that the error has been generated according to the error code stored in the memory to inform a user that the error has been generated through a warning unit (not shown), or the like, or perform an error correction operation.

As described above, when the main controlling unit 106 is operated in the error mode due to the error code stored in the memory to inform the user that the error has been generated through the warning unit, or the like, an unnecessary product repair request is generated or a self-error correction operation which is an unnecessary operation is performed.

Therefore, these problems need to be prevented. According to the preferred embodiment of the present invention, in order to prevent these problems, the voltage detecting unit 110 detects a variation in voltage and the error preventing unit 112 recognizes that the voltage has been blocked according to the variation in the voltage to prevent the operation in the error mode at the time of connecting the power supply to the main controlling unit 106.

More specifically, in the case in which the voltage of the external AC power supply 101 is blocked, the voltage induced to the secondary side of the transformer 108 and the output voltage of the second rectifying unit 109 are also blocked.

However, the power is continuously supplied to the main controlling unit 106 due to the current charged in the large capacitance capacitor C2. Here, the supplied power is gradually decreased.

Here, the DC voltage output to the main controlling unit 106 by the large capacitance capacitor C2 is divided in a predetermined ratio by the resistors R2 and R3 of the voltage detecting unit 110, such that the variation in the DC voltage is reflected.

In this case, the error preventing unit 112 receives voltage in which the variation is reflected by the resistor R3 in the divided voltages and judges whether the DC power has been blocked.

That is, the error preventing unit 112 calculates a variation rate (gradient) of the detected voltage per time and judges that the power has been blocked when the variation rate becomes a predetermined value or less.

In addition, the error preventing unit 112 may also judge that the power has been blocked in the case in which the detected voltage becomes a predetermined value or less.

As described above, when it is judged that the power has been blocked, the error preventing to unit 112 transmits a deletion signal of the error code due to the speed decrease of the SRM to the main controlling unit 106.

In this case, the main controlling unit 106 deletes the error code due to the speed decrease of the SRM stored in the memory.

As described above, when the error code due to the speed decrease of the SRM stored in the memory is deleted by the main controlling unit 106, the operation in the error mode due to the error code at the time of reconnecting the power supply to the main controlling unit 106 after blocking the power may be prevented.

As a result, generation of a product repair request due to generation of a sensing error in a normal state may be prevented in advance.

In addition, according to the preferred embodiment of the present invention, user's distrust of a product operation due the generation of the sensing error in the normal state may be prevented in advance.

Meanwhile, the error preventing unit 112 transmits an SRM stop signal to the main controlling unit 106 when it is sensed that the power has been blocked, and the main controlling unit 106 may stop start-up of the SRM when the motor stop signal is input from the error preventing unit 112.

Through the above-mentioned process, the operation of the SRM 107 may be stopped more rapidly than a time required for the main controlling unit 106 to sense the error to stop the SRM 107.

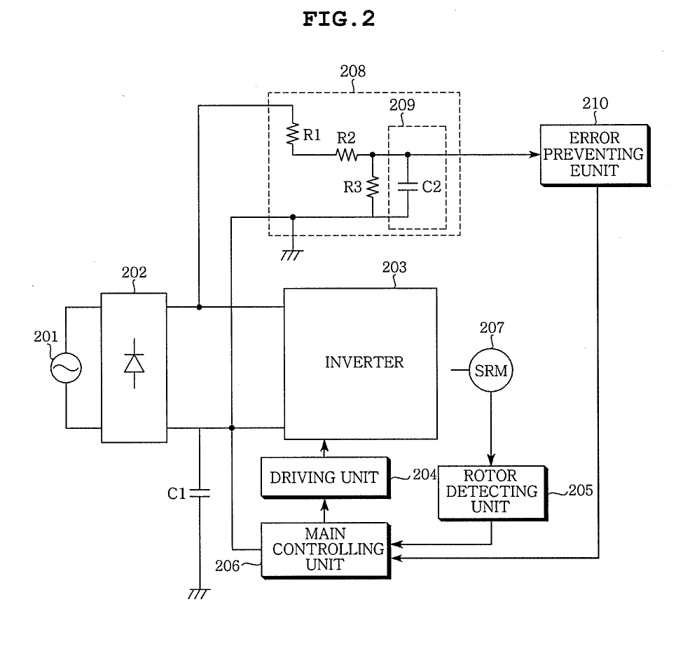

FIG. 2 is a configuration diagram of an apparatus for preventing a sensing error in an SRM according to a second preferred embodiment of the present invention.

Referring to FIG. 2, the apparatus for preventing a sensing error in an SRM according to the second preferred embodiment of the present invention is configured to include a rectifying unit 202 receiving AC voltage from an external AC power supply 201, converting the AC voltage into DC voltage, and outputting the DC voltage, an inverter 203 converting the DC voltage from the rectifying unit 202 into AC voltage and supplying the AC voltage to an SRM 207, an inverter driving unit 204 driving the inverter 203, a rotor detecting unit 205 detecting a rotation speed of a rotor of the SRM 207, a main controlling unit 206 receiving a detection signal from the rotor detecting unit 205 and reflecting the detection signal in controlling the inverter driving unit 204, a voltage detecting unit 208 detecting the output voltage of the from the rectifying unit 202 to detect a variation in power supply voltage, and an error preventing 210 detecting whether the power has been blocked using the voltage detected by the voltage detecting unit 210 to prevent an operation in an error mode at the time of reconnecting the power supply to the main controlling unit 206.

Here, the rectifying unit 202 supplies the DC voltage to the main controlling unit 206 as well as the inverter 203. Here, the DC voltage is supplied via a capacitor C1.

In addition, the voltage detecting unit 208 includes a current limiting resistor R1 limiting the voltage supplied from the capacitor C2, a plurality of voltage dividing resistors R2 and R3 setting the supply voltage to be less than a predetermined voltage value, and a low pass filter 209 configured of a low pass filter 209 removing high frequency noise mixed with voltages divided by the plurality of voltage dividing resistors R2 and R3. Here, the low pass filter 209 is configured of a capacitor C2.

Next, the error preventing unit 210 detects whether the power has been blocked using DC power passing through the low pass filter 209 and transmits a deletion signal of an error code to the main controlling unit 206 when it is detected that the power has been blocked, thereby preventing the operation in the error mode at the time of reconnecting the power supply to the main controlling unit 206.

In FIG. 2, a reference numeral C1 indicates a smoothing capacitor a pulsation component mixed with the DC power supplied from the rectifying unit 202.

An operation of the apparatus for preventing a sensing error in an SRM according to the second preferred embodiment of the present invention having the above-mentioned configuration will be described below.

The rectifying unit 202 converts the AC power applied from the AC power supply 201 into the DC voltage and outputs the DC voltage, and the inverter 203 receives the DC voltage output from the rectifying unit 202 and converts the DC voltage into the AC voltage appropriate for driving the SRM 207 and outputs the AC voltage.

Therefore, when the SRM 207 is driven, the rotor detecting unit 205 detects the rotation speed of the rotor and transmits the detection signal to the main controlling unit 206, and the main controlling unit 206 receives the detection signal from the rotor detecting unit 205 and compares the detection signal with a set reference signal and transmits a control command corresponding to the comparison result to the inverter driving unit 204.

In this case, the inverter driving unit 204 controls voltage applied to the SRM 207 according to the control command. As a result, the rotation speed of the SRM 207 is controlled.

In addition, the rectifying unit 202 supplies the DC voltage to the main controlling unit 206 as well as the inverter 203.

In this case, the rectifying unit 202 allows the DC voltage to be supplied to the main controlling unit 206 via the capacitor C1, which smoothes and supplies the power.

Current charged in the capacitor C1 continuously supplies the power to the main controlling unit 206 even though the power is removed, such that the main controlling unit 206 is operated for a predetermined time.

As a result, when the power is suddenly blocked, the speed of the SRM 207 is rapidly to decreased, but the main controlling unit 206 is continuously operated, such that the main controlling unit 206 is operated in the error mode due to the speed decrease of the SRM to continuously generate an error code and store the generated error code in a memory.

As described above, when the error code is generated by the main controlling unit 206 and the generated error code is stored in the memory, in the case in which the power supply is subsequently connected to the main controlling unit 206, the main controlling unit 206 informs a user that the error has been generated through a warning unit (not shown), or the like.

However, this is not abnormality of the SRM 207, but is the speed decrease of the SRM 207 due to the blocking of the power. In order to prevent this, the apparatus for preventing a sensing error in an SRM according to the second preferred embodiment of the present invention includes the voltage detecting unit 208 and the error preventing unit 210.

The voltage detecting unit 208 divides the DC voltage supplied from the capacitor C1 in a predetermined ratio by the resistors R2 and R3.

In addition, the error preventing unit 210 receives voltage corresponding to a voltage drop amount by the resistor R3 in the divided voltages, calculates a variation rate (gradient) of the detected voltage per time, and judges that the power has been blocked when the variation rate becomes a predetermined value or less.

In addition, the error preventing unit 210 may receive the voltage corresponding to the voltage drop amount by the resistor R3 in the divided voltages and judge that the power has been blocked in the case in which the voltage becomes a predetermined value or less.

As described above, when it is judged that the power has been blocked, the error preventing unit 210 transmits the deletion signal of the error code due to the speed decrease of the SRM to the main controlling unit 206.

In this case, the main controlling unit 206 deletes the error code due to the speed decrease of the SRM stored in the memory.

As described above, when the error code due to the speed decrease of the SRM stored in the memory is deleted by the main controlling unit 206, the operation in the error mode due to the error code at the time of reconnecting the power supply to the main controlling unit 206 after blocking the power may be prevented.

As a result, generation of a product repair request due to generation of a sensing error in a normal state may be prevented in advance.

In addition, according to the preferred embodiment of the present invention, user's distrust of a product operation due the generation of the sensing error in the normal state may be prevented in advance.

Meanwhile, the error preventing unit 210 transmits an SRM stop signal to the main controlling unit 206 when it is sensed that the power has been blocked, and the main controlling unit 206 may stop start-up of the SRM when the motor stop signal is input from the error preventing unit 210.

Through the above-mentioned process, the operation of the SRM may be stopped more rapidly than a time required for the main controlling unit 206 to sense the error to stop the SRM.

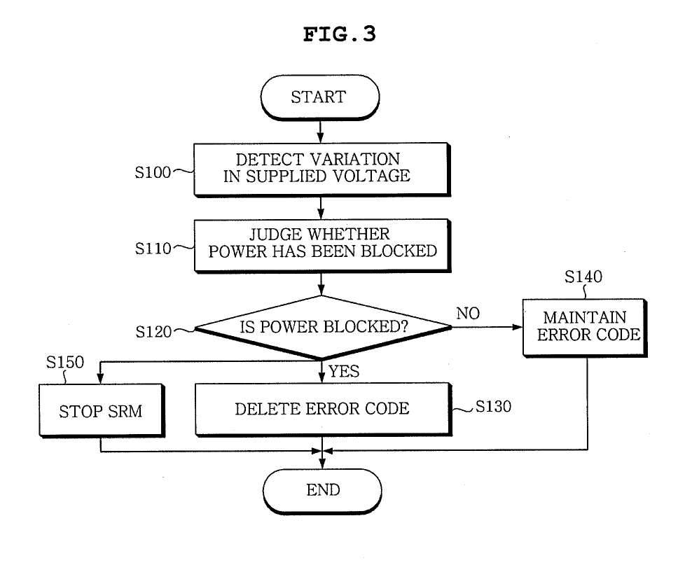

FIG. 3 is a flow chart a method for preventing a sensing error in an SRM according to the first preferred embodiment of the present invention.

Referring to FIG. 3, in the method for preventing a sensing error in an SRM according to the first preferred embodiment of the present invention, when the DC power converted from the AC power by the rectifying unit is supplied to the main controlling unit through the large capacitance capacitor, a variation in the supplied voltage is detected using the voltage detecting unit (S100).

At this time, the voltage detecting unit uses the current limiting resistor in detecting the variation in the supplied voltage to detect the variation in the supplied voltage while limiting the current, thereby preventing damage of an internal circuit.

In addition, the voltage detecting unit divides the voltage through a voltage divider in detecting the variation in the supplied voltage and detects the variation in the supplied voltage using the divided voltages.

Further, the voltage detecting unit filters the supplied voltage using the low pass filter to remove high frequency noise, thereby detecting the variation in the supplied voltage.

Then, the error preventing unit judges whether or not the power has been blocked based on the voltage detected through the voltage detecting unit (S 110).

At this time, the error preventing unit measures a variation rate of the voltage per time and judges that the power has been blocked when the variation rate (gradient) of the voltage per time is a predetermined value or more.

Alternately, the error preventing unit may judge that the power has been blocked in the case in which the voltage is decreased to a predetermined value or less.

Then, when it is judged that the power has been blocked (S120), the error preventing unit transmits the deletion signal of the error code to the main controlling unit to allow the main controlling unit to delete the error code, such that the main controlling unit is not operated in the error mode at the time of reconnecting the power supply thereto (S130).

Otherwise, in the case in which it is not judged that the power has been blocked, the error preventing unit ends without performing any operation. Therefore, the main controlling unit generates a corresponding error code in the case in which the speed of the SRM is decreased to a predetermined value due to instability of reference power to inform a user of an error or perform to processing on the error according to the corresponding error code, thereby controlling the error and storing the control result in the memory (S140).

Meanwhile, when it is sensed that the power has been blocked, the error preventing unit transmits the SRM stop signal to the main controlling unit, and the main controlling unit may stop the start-up of the SRM when the SRM stop signal is input from the error preventing unit (S 150).

Through the above-mentioned process, the operation of the SRM may be stopped more rapidly than a time required for the main controlling unit to sense the error to stop the SRM.

As set forth, according to the preferred embodiment of the present invention, the variation in the DC voltage is detected and it is judged that the power has been blocked when the DC voltage is decreased to voltage or less of commercial power to perform the normal motor stop operation, thereby making it possible to prevent the operation in the error mode at the time of subsequent connection of the power supply.

In addition, according to the preferred embodiment of the present invention, the generation of the product repair request due to the generation of the sensing error in the normal state may be prevented in advance.

In addition, according to the preferred embodiment of the present invention, the user's distrust of the product operation due the generation of the sensing error in the normal state may be prevented in advance.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An apparatus for preventing a sensing error in a switched reluctance motor (SRM), the apparatus comprising:
a rectifying unit receiving alternate current (AC) voltage into direct current (DC) voltage and supplying the DC power via a capacitor;
a main controlling unit driven by power supplied from the rectifying unit, receiving a rotation speed of a rotor of the SRM to control the SRM, and operated in an error mode in the case in which the rotation speed of the rotor is decreased to a predetermined value or less;
to a voltage detecting unit detecting a variation in the DC voltage supplied from the rectifying unit via the capacitor; and
an error preventing unit preventing an operation of the main controlling unit in an error mode at the time of reconnection of a power supply when it is sensed that the power has been blocked using the variation in the supplied voltage detected by the voltage detecting unit.

2. The apparatus as set forth in claim 1, wherein the main controlling unit generates and stores an error code in the case in which the rotation speed of the rotor is decreased to the predetermined value or less, and
the error preventing unit prevents the operation of the main controlling unit in the error mode by deleting the error code of the main controlling unit at the time of the reconnection of the power supply when it is sensed that the power has been blocked using the variation in the supplied voltage detected by the voltage detecting unit.

3. The apparatus as set forth in claim 1, wherein the error preventing unit judges that the power has been blocked in the case in which a variation rate per time in the supplied voltage detected by the voltage detecting unit is a predetermined value or more.

4. The apparatus as set forth in claim 1, wherein the error preventing unit judges that the power has been blocked in the case in which the supplied voltage detected by the voltage detecting unit is a predetermined value or less.

5. The apparatus as set forth in claim 1, wherein the voltage detecting unit includes a current limiting resistor limiting current input from the rectifying unit via the capacitor.

6. The apparatus as set forth in claim 1, wherein the voltage detecting unit includes a current divider dividing current input from the rectifying unit via the capacitor, and
the error preventing unit uses any one of the DC voltages divided by the current divider.

7. The apparatus as set forth in claim 1, wherein the voltage detecting unit includes a low pass filter removing high frequency noise input the voltage detecting unit.

8. The apparatus as set forth in claim 1, wherein the rectifying unit receives the AC voltage from an external AC power supply, converts the AC voltage into the DC voltage, and supplies the DC voltage to the SRM via an inverter.

9. The apparatus as set forth in claim 1, wherein the error preventing unit transmits an SRM stop signal to the main controlling unit when it is sensed that the power has been blocked, and
the main controlling unit stops start-up of the SRM when the SRM stop signal is input from the error preventing unit.

10. A method for preventing a sensing error in an SRM, the method comprising:
(A) detecting, in a voltage detecting unit, a variation of DC voltage supplied from a rectifying unit via a capacitor; and
(B) preventing, in an error preventing unit, an operation of a main controlling unit in an error mode at the time of reconnection of a power supply when it is sensed that the power has been blocked using the variation in the supplied voltage detected by the voltage detecting unit.

11. The method as set forth in claim 10, further comprising:
(C) transmitting, in the error preventing unit, an SRM stop signal to the main controlling unit when it is sensed that the power has been blocked using the variation in the supplied voltage detected by the voltage detecting unit;
(D) stopping, in the main controlling unit, start-up of the SRM when the SRM stop signal is input from the error preventing unit.

12. The method as set forth in claim 10, wherein in step (B), the error preventing unit judges that the power has been blocked in the case in which a variation rate per time in the supplied voltage detected by the voltage detecting unit is a predetermined value or more.

13. The method as set forth in claim 10, wherein in step (B), the error preventing unit judges that the power has been blocked in the case in which the supplied voltage detected by the voltage detecting unit is a predetermined value or less.
